(19) United States
(12) Patent Application Publication
(10) Pub. No.: US 2013/0268483 A1
(43) Pub. Date: Oct. 10, 2013

(54) INFORMATION PROCESSING APPARATUS, INFORMATION PROCESSING METHOD, AND COMPUTER PROGRAM

(71) Applicant: SONY CORPORATION, Tokyo (JP)

(72) Inventors: Ugo Di Profio, Kanagawa (JP); Satoshi Asakawa, Tokyo (JP); Kiyoto Ichikawa, Tokyo (JP); Keiichi Yamada, Tokyo (JP)

(73) Assignee: SONY CORPORATION, Tokyo (JP)

(21) Appl. No.: 13/851,423

(22) Filed: Mar. 27, 2013

(30) Foreign Application Priority Data
Apr. 6, 2012 (JP) 2012-087218

(51) Int. Cl. G06F 17/30

(52) U.S. Cl. CPC G06F 17/30345
USPC 707/609

(57) ABSTRACT

There is provided an information processing apparatus including an information gathering unit gathering information relating to a user, an information constructing unit constructing, from the information gathered by the information gathering unit, personal information on the user based on information disclosed by the user, and an information disclosure control unit dynamically changing a disclosed content of the personal information constructed by the information constructing unit, depending on another user.

### BACKGROUND

The present disclosure relates to an information processing apparatus, an information processing method, and a computer program.

Mobile information processing apparatuses, as represented by smartphones, have become widespread, and it has become increasingly common for social networking services (SNS) to be used on such apparatuses. SNS greatly facilitate communication between people, and it is expected that interpersonal communication performed via SNS and other cloud-type web services will have an increasingly important role in the future.

Recently, it has become typical for users to have accounts on a plurality of SNS and other web services, resulting in information being registered in a distributed manner across such SNS and web services. If such distributed information could be gathered together, it would be possible to consolidate the personal information, which would be beneficial for communication. One example of software (agent software) for automatically gathering information on a network is disclosed in Japanese Laid-Open Patent Publication No. 2006-259867.

### SUMMARY

Although SNS and other cloud-type web services facilitate communication between people, direct communication with another person using such services has a limitation in that the other person has to be using the service at the same time. SNS and other cloud-type web services also place limitations on or hinder communication with people the user does not know, and are often also limited to communication with a single person at a time.

When registered information that is distributed among a plurality of SNS and other web services is automatically gathered together, unless limitations are provided on the disclosure of such information, information can be disclosed to people unfamiliar to the user or to people to whom the user does not want such information disclosed.

The present disclosure aims to provide a new and improved information processing apparatus, information processing method, and computer program that facilitate interpersonal communication by gathering information and are also capable of placing recipient-dependent limitations on the disclosure of information.

According to an embodiment of the present disclosure, there is provided an information processing apparatus including an information gathering unit gathering information relating to a user, an information constructing unit constructing, from the information gathered by the information gathering unit, personal information on the user based on information disclosed by the user, and an information disclosure control unit dynamically changing a disclosed content of the personal information constructed by the information constructing unit, depending on another user.

Further, according to an embodiment of the present disclosure, there is provided an information processing method including gathering information relating to a user, constructing, from the information gather in the step of gathering information, personal information on the user based on information disclosed by the user, and dynamically changing a disclosed content of the personal information constructed in the step of constructing personal information, depending on another user.

Further, according to an embodiment of the present disclosure, there is provided a computer program for causing a computer to execute gathering information relating to a user, constructing, from the information gathered in the step of gathering information, personal information on the user based on information disclosed by the user, and dynamically changing a disclosed content of the personal information constructed in the step of constructing personal information, depending on another user.

As described above, according to the embodiments of the present disclosure, it is possible to provide a new and improved information processing apparatus, information processing method, and computer program that facilitate interpersonal communication by gathering information and are also capable of placing recipient-dependent limitations on the disclosure of information.

### BRIEF DESCRIPTION OF THE DRAWINGS

FIG. 1 is a diagram useful in explaining an example system configuration of an information system 1 according to an embodiment of the present disclosure;

FIG. 2 is a diagram useful in explaining an example configuration of an agent according to the same embodiment of the disclosure;

FIG. 3 is a diagram useful in explaining one example of a case where the current location of the user is known using an API;

FIG. 4 is a diagram useful in explaining the overall operation of the information system 1 including an agent 100a;

FIG. 5A is a diagram useful in explaining an example operation of an agent according to the present embodiment of the disclosure;

FIG. 5B is a diagram useful in explaining an example operation of an agent according to the present embodiment of the disclosure;

FIG. 6 is a diagram useful in explaining an example operation of an agent according to the present embodiment of the disclosure;

FIG. 7A is a diagram useful in explaining an example operation of an agent according to the present embodiment of the disclosure;

FIG. 7B is a diagram useful in explaining an example operation of an agent according to the present embodiment of the disclosure;

FIG. 8 is a diagram useful in explaining an example operation of an agent according to the present embodiment of the disclosure;

FIG. 9 is a diagram useful in explaining one example of a setting screen for personal information;

FIG. 10 is a diagram useful in explaining one example of a user interface for changing the content of information on a user constructed by an agent; and

FIG. 11 is a diagram useful in explaining an example of a user interface for confirming activities of an agent.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description is given in the order indicated below.

### 1. Embodiment of the Disclosure

Example of System Configuration

Example of Agent Configuration

Example Operations of Agent

Example of User Interface

### 2. Conclusion

### 1. Embodiment of the Disclosure

### Example of System Configuration

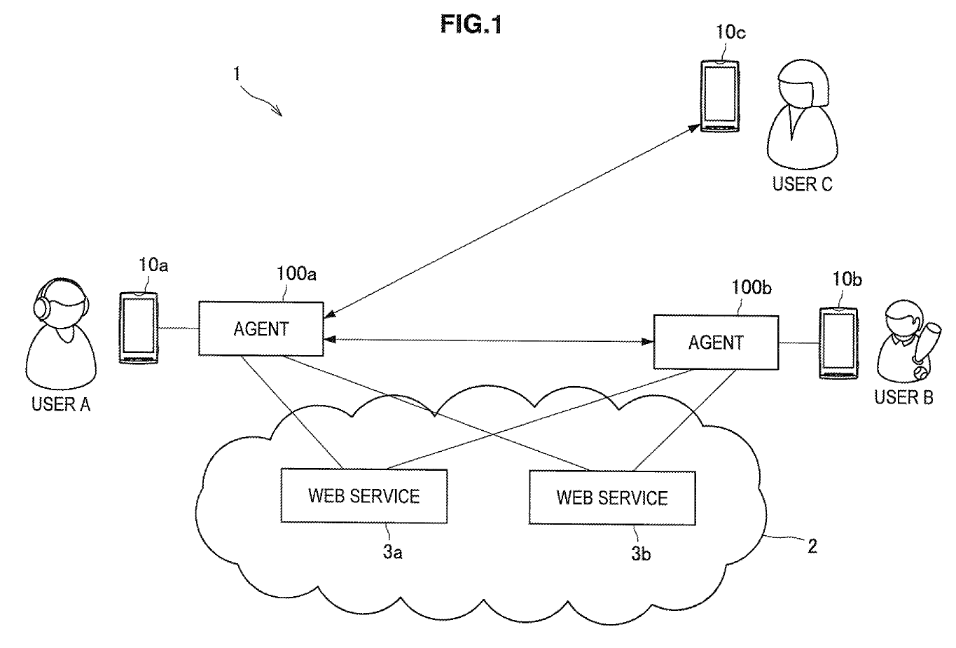

FIG. 1 is a diagram useful in explaining an example system configuration of an information system 1 according to an embodiment of the present disclosure. An example system configuration of the information system 1 according to the present embodiment of the disclosure will now be described with reference to FIG. 1.

As shown in FIG. 1, the information system 1 according to the present embodiment includes web services 3a, 3b provided on a network 2 and agents 100a, 100b that gather information from information processing apparatuses 10a, 10b used by users.

The agent 100a automatically gathers information on the user A from the web services 3a, 3b to construct information on the user A in a database 110a. Examples of web services provided on the network 2 include a social networking service (SNS), a location information service, a calendar service, a time management service, and a ToDo management service. The agent 100a also uses the information processing apparatus 10a. As examples, the information processing apparatus 10a may be a desktop computer, a laptop computer, a smartphone, a tablet, or another mobile terminal. The agent 100a gathers information about the user A from operation information for the information processing apparatus 10a being used by the user A (for example, information on software executed by the information processing apparatus 10a and/or the content of an operation being carried out by the user A on such software) to construct information on the user A in the database 110a. The information processing apparatus 10a changes the settings of the agent 100a in accordance with an operation by the user A.

Although the agent 100a is shown in FIG. 1 as being separate to both the information processing apparatus 10a and the network 2, the agent 100a may be configured so as to be provided inside the information processing apparatus 10a or may be configured so as to be provided on the network 2.

The two agents 100a, 100b are shown in FIG. 1. The agent 100a constructs information about the user A and the agent 100b constructs information about the user B. Three information processing apparatuses 10a, 10b, and 10c are also shown in FIG. 1. It is assumed here that the information processing apparatus 10a is used by the user A, the information processing apparatus 10b is used by the user B, and the information processing apparatus 10c is used by the user C.

The agent 100a discloses information on the user A constructed in the database 110a in response to inquiries from other agents (i.e., the agent 10b) and/or information processing apparatuses used by users aside from the user A (i.e., the information processing apparatuses 10b, 10c). Here, the agent 100a changes the range and content of the disclosed information on the user A constructed in the database 110a depending on the source of an inquiry. As one example, if the relationship between the user A and the user B is extremely close, the agent 100a discloses the information on the user A constructed in the database 110a without processing the information. Meanwhile, if the relationship between the user A and the user C is not close or the user C is a complete stranger, or if the relationship is such that the user A does not want the user C to know information about himself/herself, the agent 100a can disclose information on the user A constructed in the database 110a after processing, can limit the disclosed range, or can alternatively disclose none of the information. As examples, the relationships of the user A with the user B and the user C may be automatically decided from the web services 3a, 3b or may be set by the user A.

The information system 1 according to the present embodiment of the disclosure is capable of communication from user to agent, from agent to user, and between agents. The respective agents are constructed as information providers so that information on a certain user can be obtained not only from the user himself/herself but also via an agent of such user. The provision of information to a given user can also be carried out via the agent of such user. Also, if someone wishes to contact a certain user that such person does not know well, it is possible to have an introduction made via the agent of such user.

This completes the description of an example system configuration of the information system 1 according to the present embodiment of the disclosure with reference to FIG. 1. Next, an example configuration of an agent according to the present embodiment will be described with reference to FIG. 1.

### Example Configuration of Agent

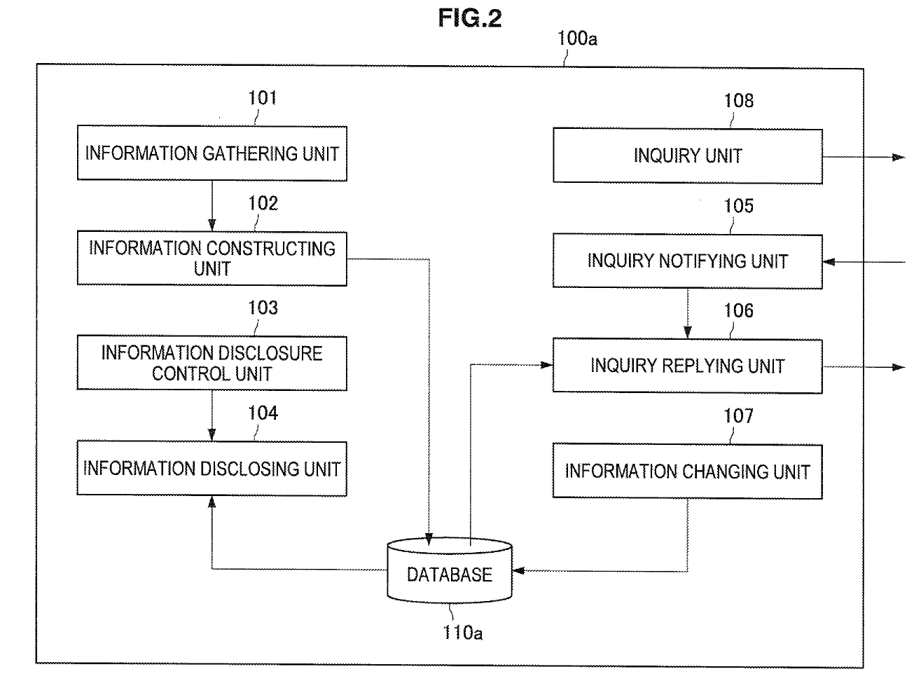

FIG. 2 is a diagram useful in explaining an example configuration of an agent according to the present embodiment of the disclosure. In FIG. 2, an example configuration of the agent 100a that is the agent of the user A shown in FIG. 1 is shown as the example configuration of an agent. The configuration of the agent 100a according to the present embodiment of the disclosure will now be described with reference to FIG. 2.

As shown in FIG. 2, the agent 100a according to the present embodiment includes an information gathering unit 101, an information constructing unit 102, an information disclosure control unit 103, an information disclosing unit 104, an inquiry notifying unit 105, an inquiry replying unit 106, an information changing unit 107, and an inquiry unit 108.

The information gathering unit 101 gathers disclosed information about the user A. The information gathering unit 101 gathers disclosed information about the user A from information registered in the web services 3a, 3b provided on the network 2 and the operation state and the like of the information processing apparatus 10a used by the user A. Although the frequency with which disclosed information about the user A is gathered by the information gathering unit 101 is not limited to specified timing, as one example it is possible to obtain the latest information about the user A by gathering information on receiving notification that there has been a change to the information registered in the web services 3a, 3b provided on the network 2 or to the operating state of the information processing apparatus 10a being used by the user A when such change has occurred.

Also, if a web service provided on the network 2 is set so as to operate in concert with the agent 100a, the information gathering unit 101 may gather information by regularly monitoring such web services. As one example, the information gathering unit 101 may use authorization by a secure API (Application Programming Interface) such as OAuth to automatically gather data (location information, status, schedule, and the like) for an individual user from respective services. As examples, the data gathered by the information gathering unit 101 may be written in a format such as XML or JSON. When gathering information, the information gathering unit 101 may use an activity stream where user activities on social media such as SNS are handled as a list. The information gathering unit 101 may also gather information obtained by voice recognition as information relating to an individual user.

The information constructing unit 102 constructs disclosed information about the user A that has been gathered by the information gathering unit 101. The information constructing unit 102 constructs individual information on the user A by managing the information gathered by the information gathering unit 101 in units of predetermined attributes. Although there are various conceivable methods by which the information constructing unit 102 may construct the information. For example, the information constructing unit 102 may carry out modeling according to 5W1H (Who, What, When, Where, Why, How) to continuously sort the data gathered by the information gathering unit 101 and grasp the detailed state of the user.

Examples of the “Who” information include information on who is currently with the user or on who the user is about to meet. As examples, such information may be gathered from a calendar service or a check-in function or the like provided on an SNS, and it is also possible to use the result of a facial recognition function, a voice recognition function, or the like for people currently with the user.

Examples of the “What” information include information on what the user is doing, such as whether the user is walking, running, or riding a train, or on what work the user is doing using the information processing apparatus 10a. As examples, such information may be gathered from a calendar service, a ToDo service, or the like, or in a case where sensors such as a location sensor and an acceleration sensor are provided in the information processing apparatus 10a, may be gathered from such sensors. It is also possible to use the result of recognition by a voice recognition function or the like (showing for example that the user is having a conversation with someone), and to gather information from the operation state of the information processing apparatus 10a that is being used by the user A.

Examples of the “When” information include the start and end times of the current action being carried out by the user or the user's next engagement. As examples, such information may be gathered from a calendar service or a schedule service or may be gathered from the operation state of the information processing apparatus 10a being used by the user.

Examples of the “Where” information include information on where the user was previously located, where the user is now, or where the user is to about to go. As examples, such information may be gathered from a calendar service or a schedule service, may be gathered from a check-in function provided on an SNS, or in a case where a location sensor is provided in the information processing apparatus 10a, may be gathered from such sensor.

Examples of the “Why” information include information on why the user is carrying out an action and/or the object of such action. As examples, such information may be gathered from a calendar service or an SNS service, or may be gathered from the operation state of the information processing apparatus 10a being used by the user A. When the information is gathered from the operation state of the information processing apparatus 10a being used by the user A, as examples it is possible to use the content of electronic mail (hereinafter simply “e-mail”) transmitted by the user A and/or the type, content, and the like of software being used by the user A.

Examples of the “How” information include information on how the user is acting or on what tools the user is using. As examples, such information may be gathered from a calendar service or a schedule service, may be gathered from content posted on an SNS, or may be gathered from the operation state of the information processing apparatus 10a being used by the user A. When the information is gathered from the operation state of the information processing apparatus 10a being used by the user A, as an example it is possible to use the type, content, and the like of software being used by the user A.

The information constructing unit 102 systematically constructs information disclosed about the user A that has been gathered by the information gathering unit 101. The information constructing unit 102 stores the information that has been constructed from the information gathered by the information gathering unit 101 in the database 110a.

The information disclosure control unit 103 controls the disclosed content of the information that has been constructed by the information constructing unit 102 and stored in the database 110a. As described earlier, although the information constructing unit 102 constructs information about the user A from the information gathered by the information gathering unit 101, such information is so-called “raw data” about the user A. Disclosure of the raw data about the user A without any limitations would be problematic from the viewpoint of privacy. Accordingly, when the information stored in the database 110a is disclosed by the information disclosing unit 104, described later, the information disclosure control unit 103 manages the disclosed content of the information stored in the database 110a.

When the disclosed content of the information stored in the database 110a is managed by the information disclosure control unit 103, as examples the disclosed range may be set by the user, a privacy setting of a web service that operates in concert with the agent 100a may be used, or if no setting has been made, the user may be asked to permit the disclosure of information on a point by point basis. One example of a privacy setting of a web service that operates in concert with the agent 100a is a setting of a disclosed range of information in accordance with whether a person is a friend on an SNS. If the present user is registered on an SNS as a friend of another user, the information disclosure control unit 103 carries out control so that the information stored in the database 110a is disclosed up to a detailed level to such other user. Meanwhile, if the present user is not registered on an SNS as a friend of another user, the information disclosure control unit 103 carries out control so that the information stored in the database 110a is disclosed to such other user in an ambiguous and/or abstract manner.

For example, if a schedule function is provided on an SNS from which the information gathering unit 101 gathers information and the present user is registered as the friend of another user on the SNS, the information disclosure control unit 103 carries out control so that the schedule registered in the schedule function is disclosed as it is to the other user (or the agent of the other user). Meanwhile, if the present user is not registered as the friend of another user on the SNS, the information disclosure control unit 103 carries out control so that the schedule registered in the schedule function is not disclosed as it is to the other user and instead only the existence of an appointment of some kind is disclosed to the other user (or the agent of the other user). Also, even if the present user is registered as the friend of another user on the SNS, there are cases where it is desirable to change the disclosed content of information according to whether the user also has a relationship with the other user in real life or has a relationship on the SNS only. In view of such situation, the information disclosure control unit 103 may decide whether the information stored in the database 110a is to be disclosed to a detailed level in accordance with the extent of the relationship with the other user.

A case where the user sets the disclosed range will now be described in more detail. Although many SNS have a function where the disclosed range of information can be set precisely in accordance with the relationship with other users, the information disclosure control unit 103 may precisely set the disclosed range of the information stored in the database 110a according to a user setting. As one example, the disclosed range of location information may be divided into a plurality of levels such as “disclose information acquired by GPS”, “disclose information to town level”, “disclose information to prefecture/state level”, and “do not disclose” according to the relationship with another user, with the level of information obtained by respective users being set in the information disclosure control unit 103. It is also possible to group the users and for the information disclosure control unit 103 to change the disclosure level in group units according to a user setting.

A case where a privacy setting of a web service that operates in concert with the agent 100a is used will now be described in more detail. As one example, if the agent 100a is operating in concert with a mail service, the information disclosure control unit 103 may use groups in a contact list on such mail service. As another example, if the agent 100a is operating in concert with a location information service, the information disclosure control unit 103 may use a sharing setting of such location information service. As yet another example, for users who are friends on an SNS, the information disclosure control unit 103 may make a setting so that information is disclosed up to a specified level.

A case where the user is asked to permit the disclosure of information on a point by point basis will now be described in more detail. As one example, if another user (or the terminal used by such other user) or another agent is accessing information constructed by the agent 100a in the database 110a, the information disclosure control unit 103 asks such other user or agent the reason for accessing the information constructed in the database 110a. When asking the present user for permission, the information disclosure control unit 103 may present the answer received in response from the other user so that the present user can use such answer in determining whether to permit disclosure. One example of a received answer would be “You are late for our meeting, so I′d like to know where you are.”

The information disclosure control unit 103 may automatically learn the disclosed range of information from the results of the user determining whether to permit disclosure. As one example, if determinations to permit the disclosure of information to a specified user are made consecutively, the information disclosure control unit 103 may make a setting so that information is actively disclosed to such specified user. As another example, if determinations to prohibit the disclosure of information to a specified user are made consecutively, the information disclosure control unit 103 may make a setting so that information is not disclosed to such specified user.

The information disclosing unit 104 discloses information constructed in the database 110a. The information disclosing unit 104 discloses the information constructed in the database 110a in response to a request from another user or an agent. When disclosing the information constructed in the database 110a, the information disclosing unit 104 discloses the information based on the disclosed content controlled by the information disclosure control unit 103.

As one example, if there has been access to the information constructed in the database 110a from the information processing apparatus 10b used by the user B and the content of the information disclosed to the user B is limited by the information disclosure control unit 103, the information disclosing unit 104 discloses the information constructed in the database 110a to the user B within the range limited by the information disclosure control unit 103. If, as one example, the disclosure level “disclose to town level” has been set for the user B relating to location information, when disclosing location information from the information constructed in the database 110a, the information disclosing unit 104 discloses information in a form where the information is limited to town level.

When disclosing the information constructed in the database 110a, the information disclosing unit 104 is capable of protecting the privacy of the user A by disclosing information based on the disclosed content controlled by the information disclosure control unit 103.

If there has been an inquiry from another user or agent about the information constructed in the database 110a, the inquiry notifying unit 105 notifies the user A that there has been an inquiry. To give notification that there has been an inquiry about the information constructed in the database 110a, as one example the inquiry notifying unit 105 may transmit e-mail to the user, or for cases such as where the user is carrying the information processing apparatus 10a, a signal that has information displayed on a screen of the information processing apparatus 10a, has the information processing apparatus 10a vibrate, and/or has a sound emitted from the information processing apparatus 10a may be transmitted to the information processing apparatus 10a.

The inquiry replying unit 106 replies in place of the user to an inquiry from the other user or agent. If it is not possible for the user to directly reply to an inquiry from another user or agent, in place of the present user the inquiry replying unit 106 replies to the other user using the information constructed in the database 110a.

As one example, if the information processing apparatus 10a is a mobile phone and the other user or agent has telephoned the information processing apparatus 10a of the user A but the user A is unable to answer the call, the inquiry replying unit 106 provides a spoken reply in place of the user A. In this way, the agent 100a carries out communication with the other user or agent as a representative of the user A.

The information changing unit 107 makes changes to the information constructed in the database 110a. The information changing unit 107 may present the information constructed in the database 110a to the information processing apparatus 10a, have the user change the presented information, and have the changed information reflected in the database 110a. The user may also use the information processing apparatus 10a to directly change the information constructed in the database 110a. In this case, the information changing unit 107 has the content inputted into the information processing apparatus 10a reflected in the database 110a. The inputting of information into the information processing apparatus 10a is not limited to only characters and may be carried out using images and/or audio/speech.

The inquiry unit 108 makes an inquiry about personal information of the user corresponding to the agent that has been gathered by another agent. Using the inquiry unit 108, the agent 100a is capable of making an inquiry about information to another agent. More specifically, as one example, the agent 100a that has received a request from the present user to acquire information on another user makes an inquiry, via the inquiry unit 108, to the agent of such other user for information on the other user. The inquiry unit 108 may make an inquiry about information to the agent of another user even when there has been no request from the present user. By doing so, the exchanging of information between agents is automatically carried out without involving users.

By using a configuration such as that shown in FIG. 2, the agent 100a is capable of gathering information about the user A, constructing information in the database 110a, and disclosing the information constructed in the database 110a limited to an appropriate range in response to an inquiry from another user or another agent. If the user A is not capable of directly replying to an inquiry from another user or another agent, the agent 100a is capable of replying to such inquiry in place of the user A.

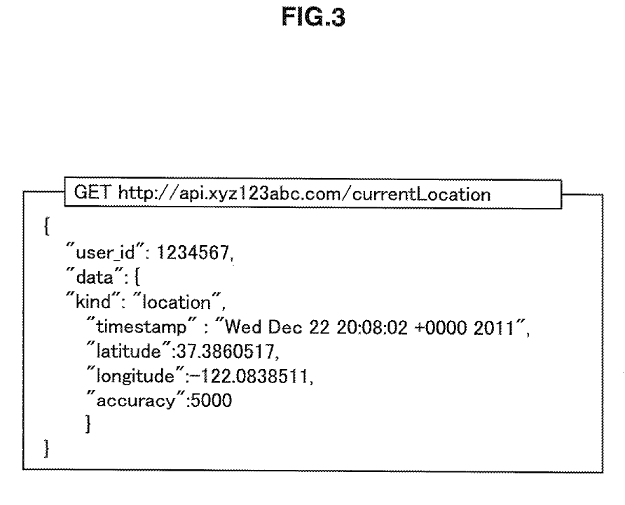

The agent 100a is configured so as to be capable of communication with another user (or the information processing apparatus used by another user) or another agent. To do so, as one example the agent 100a may have an API (Application Program Interface) for accessing information constructed in the database 110a. More specifically, as one example the agent 100a may have an API for accessing information constructed in the database 110a as a REST (REpresentational State Transfer) web service. If the agent 100a has an API, it becomes possible via the API to add to the information constructed in the database 110a or to change or delete information and possible to conduct programmable operations of the information constructed in the database 110a. FIG. 3 is a diagram useful in explaining one example of a case where the current location of the user is known using an API. FIG. 3 shows an example where the current location is acquired by enquiring to the illustrated URL about the current location.

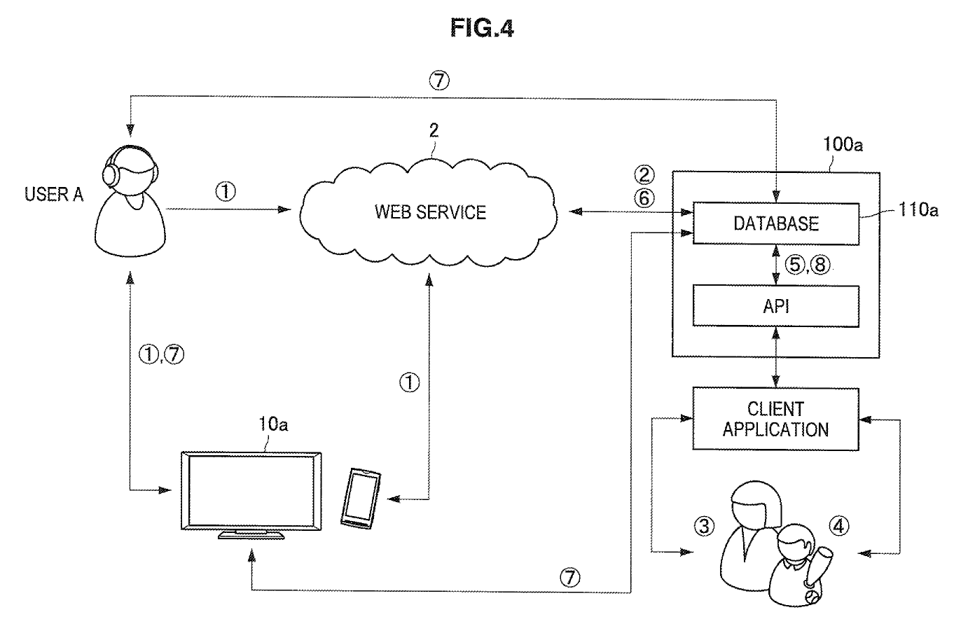

FIG. 4 is a diagram useful in explaining the overall operation of the information system 1 that includes the agent 100a. First, the user A uses the information processing apparatus 10a or the like to construct information on himself/herself on a network (1). The information on the user A constructed on the network is data gathered by the agent 100a and constructed in “5W1H” format (2).

Assume here that a different user to the user A attempts to acquire information about the user A via the API provided in the agent 100a (3, 4). The agent 100a determines whether the requested information is registered in the database 110a (5) and provides the information to the user who made the request if the information is stored in the database 110a. When providing information, the agent 100a does so having masked the information in accordance with the relationship between the user A and the user who made the request. If the requested information is not stored in the database 110a, the agent 100a tries to acquire the information from a web service on the network (6) and when such information can be gathered, provides the information to the user who made the request (8). If it is not possible to gather the information from a web service on the network, the agent 100a tries to directly gather the information from the user A or a device (the information processing apparatus 10a) being used by the user A (7).

This completes the description of the configuration of the agent 100a according to the present embodiment of the disclosure with reference to FIG. 2. Next, the operation of an agent according to an embodiment of the present disclosure will be described by way of a number of actual examples. Example Operations of Agent

### (1) First Example Operation

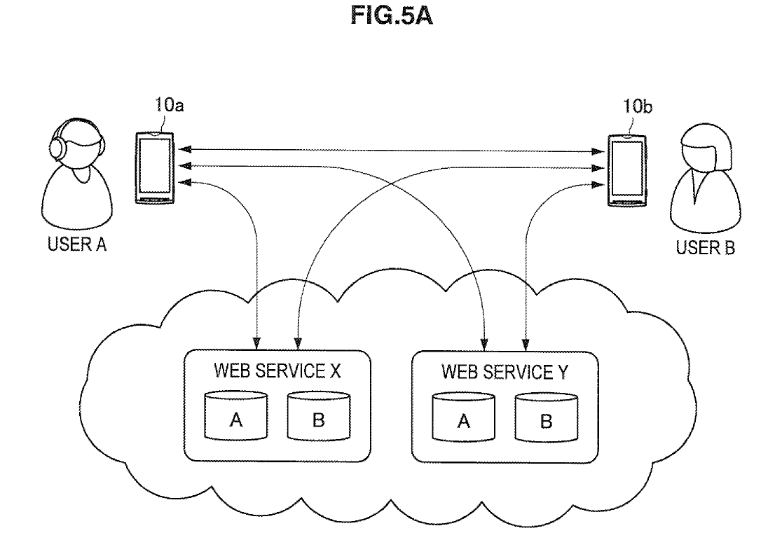

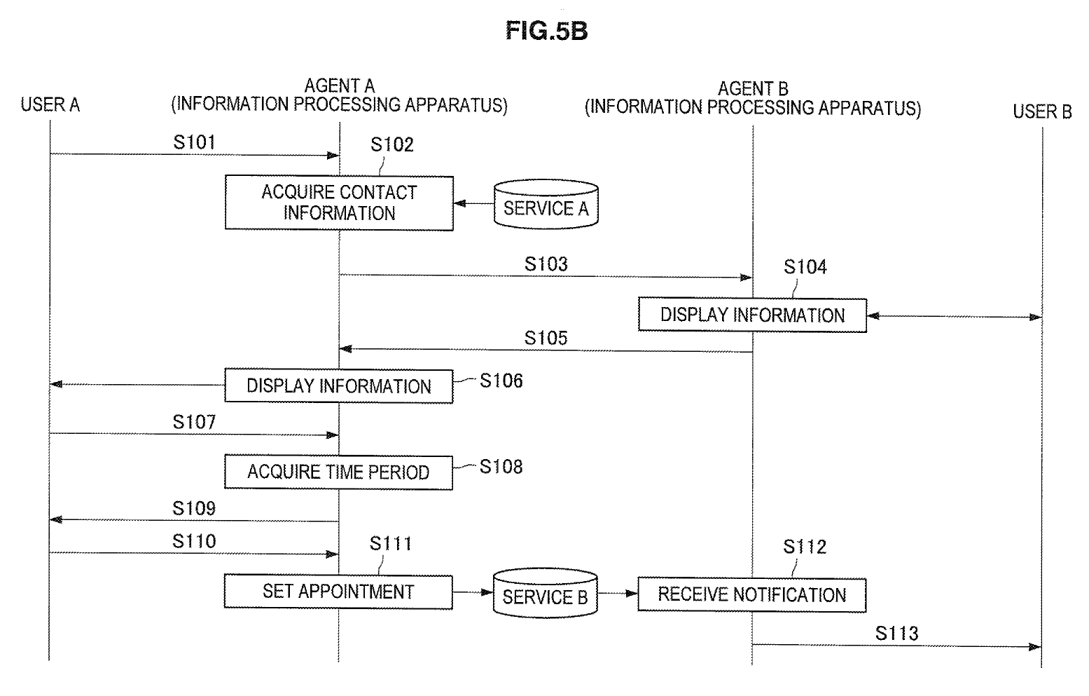

FIG. 5A and FIG. 5B are diagrams useful in explaining an example operation of an agent according to the present embodiment of the disclosure. FIG. 5A and FIG. 5B show an example operation in a case where communication is carried out between the user A and the user B who both have agents. Note that it is assumed here that the user A and the user B already know each other. The agent 100a of the user A and the agent 100b of the user B are also assumed to both have a configuration such as that shown in FIG. 2 and to have already constructed information about their respective users. A first example operation of an agent according to the present embodiment of the disclosure will now be described with reference to FIG. 5A and FIG. 5B.

First, the user A informs the agent 100a that he/she wishes to contact the user B (step S101). The agent 100a then acquires contact information for the user B from the service X on the network (step S102). To acquire the contact information for the user B from the service X on the network, if for example the service X is an SNS whose API is disclosed, the agent 100a acquires the contact information using such API.

Once the agent 100a has acquired the contact information of the user B, the information processing apparatus 10a uses the information acquired by the agent 100a to transmit information requesting contact from the information processing apparatus 10a to the information processing apparatus 10b (step S103). As examples, such transmission of information may be a telephone call or transmission of e-mail.

Once the information requesting contact has been transmitted from the information processing apparatus 10a to the information processing apparatus 10b, the agent 100b of the user B receives such information, has the information processing apparatus 10b display an indication that there has been contact from the user A, and provides selection options for replying to such contact (step S104). As the selection options for replying, “Answer voice call”, “Answer video call”, and “Can't answer now” and the like may be provided for an example case where the information processing apparatus 10a has made a telephone call to the information processing apparatus 10b.

Here, assume that “Can't answer now” has been selected by the user B out of the selection options described above. In response, the information processing apparatus 10b transmits information corresponding to such selection of “Can't answer now” to the information processing apparatus 10a (step S105). Based on the information sent from the information processing apparatus 10b, the information processing apparatus 10a displays an indication that the user B is incapable of replying at the moment (step S106). At this time, due to the agent 100a relaying the information sent from the information processing apparatus 10b, the agent 100a is capable of behaving so as to provide the user A with a response to the user A notifying the agent 100a in step S101 described above that the user A wishes to contact the user B. Note that aside from displaying information in step S106, it is also possible to inform the user A that the user B is incapable of replying at the moment by having the information processing apparatus 10a output sound or speech for example.

After this, the user A requests the agent 100a to acquire a time period where an appointment with the user B can be made (step S107). The agent 100a receives the request from the user A and acquires information relating to the schedule of the user B from the service Y on the network (step S108). The agent 100a then acquires the information relating to the schedule of the user B from the service Y on the network and notifies the user A via the information processing apparatus 10a of a time period where an appointment with the user B can be made (step S109).

The user A views such time period where an appointment with the user B can be made that has been indicated by the agent 100a and, if an appointment in such time period is desired, instructs the agent 100a to make an appointment with the agent 100a (step S110). Based on the instruction from the user A, the agent 100a sets an appointment in the described time period on the service Y on the network (step S111).

When the agent 100b is notified from the service Y that the appointment has been set by the agent 100a of the user A on the service Y on the network (step S112), the agent 100b notifies the user B, such as by displaying on the information processing apparatus 10b, that an appointment has been set by the agent 100a of the user A on the service Y on the network (step S113). The user B views the notified content and determines whether to permit the setting of the appointment.

In this way, even if direct communication is not performed between the user A and the user B, by exchanging information between the agent 100a of the user A and the agent 100b of the user B by acquiring information registered in a service on the network, it is possible to carry out indirect communication between the user A and the user B via the agent 100a of the user A and the agent 100b of the user B.

Note that when the user B is having a conversation with the agent of the user A via a telephone call for example, since it is not problematic for the user B to realize that he/she is conversing with an agent, the agent does not necessarily have to have an artificial intelligence-like capability. That is, when the agent of the user A is conversing by telephone with the user B, it is possible to carry out a conversation using standard spoken responses, such as “The user A is not able to answer the telephone at the moment”.

### (2) Second Example Operation

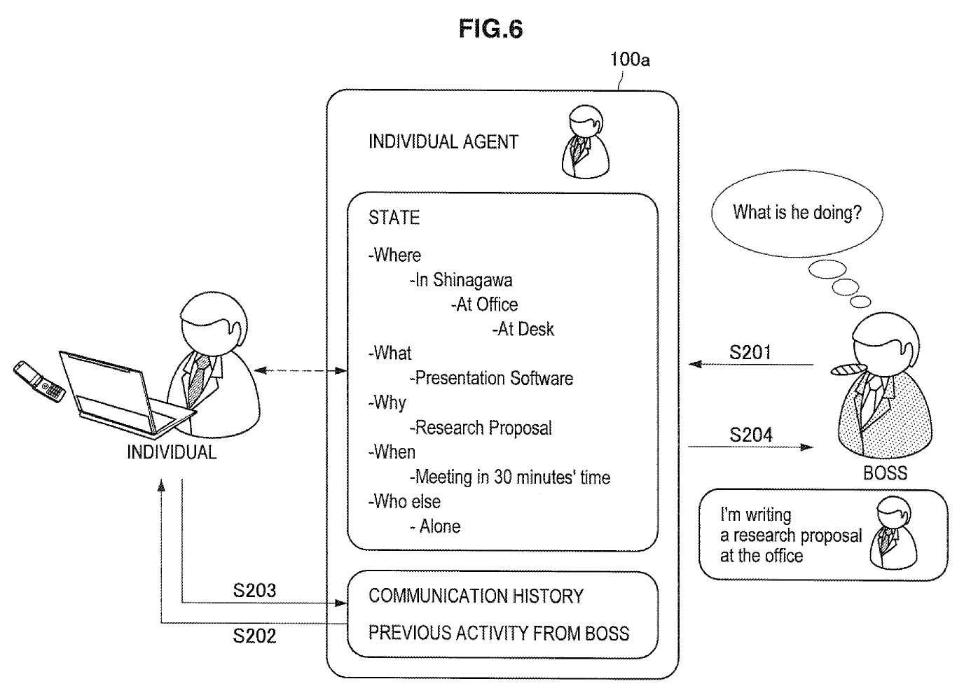

FIG. 6 is a diagram useful in explaining an example operation of an agent according to the present embodiment of the disclosure. FIG. 6 shows an example operation in an example case where the boss at a workplace makes an inquiry to a subordinate agent about the state of a subordinate. An example operation of an agent according to the present embodiment of the disclosure will now be described with reference to FIG. 6.

While out of the office, the boss makes an inquiry to the agent 100a of a subordinate about the state of such subordinate (step S201). As one example, the inquiry to the agent 100a can be made from a mobile information terminal or the like carried by the boss.

When the agent 100a of the subordinate has received an inquiry into the state of the subordinate from the boss, the agent 100a gathers information on the state of the subordinate, who is the user of the agent 100a, from the information constructed in the database 110a and sends such gathered information in reply. First, the agent 100a notifies the subordinate who is the user that an inquiry has been made from the boss (step S202). The notification in step S202 is carried out according to a specified method for a personal computer or mobile telephone used by such subordinate, for example. If the subordinate responds by giving permission to reply (step S203), the agent 100a gathers together and sends in reply the state of the subordinate who is the user from the information constructed in the database 110a (step S204).

In the example shown in FIG. 6, “Desk” at the “Office” in “Shinagawa” is stored in the “Where” information, “Presentation software” is stored in the “What” information, “Research proposal” is stored in the “Why” information, “Meeting in thirty minutes' time” is stored in the “When” information, and “Alone” is stored in the “Who else” information. From such information, as one example the agent 100a sends a reply with a content such as “I′m writing a research proposal at the office” to the boss. The content of the reply sent by the agent 100a may be changed in accordance with the relationship between the boss and the subordinate. As examples, when replying, the agent 100a may use detailed information on the subordinate constructed in the database 110a or may use an ambiguous and/or abstract version of the information on the subordinate constructed in the database 110a.

### (3) Third Example Operation

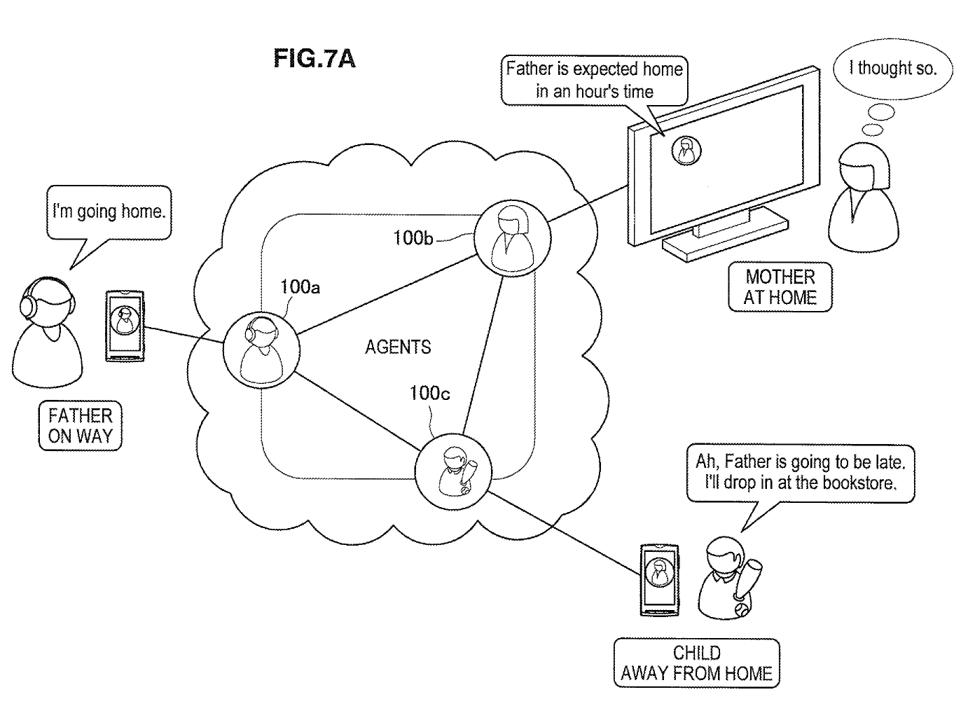

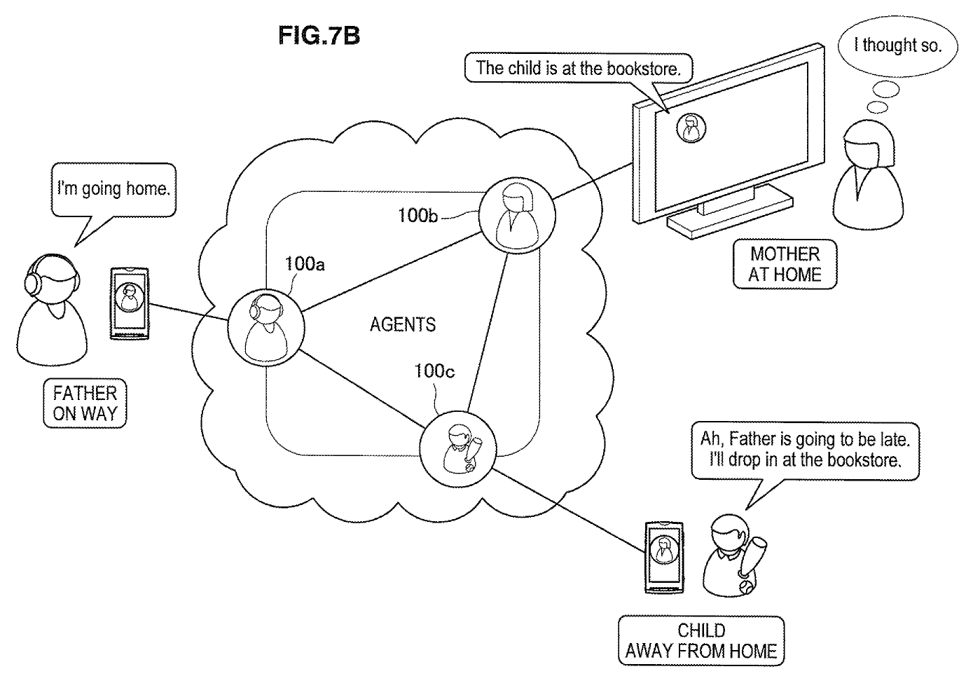

FIG. 7A and FIG. 7B are diagrams useful in explaining an example operation of agents according to the present embodiment of the disclosure. FIG. 7A and FIG. 7B show a situation where agents are used for communication between family members, the father, the mother, and the child all have their own agent and communication is carried out between family members via such agents. An example operation of agents according to the present embodiment of the disclosure will now be described with reference to FIG. 7A and FIG. 7B.

As one example, the father uses a mobile information terminal to tell the agent 100a that he is about to return home. The agent 100a informs the agent 100b of the mother and the agent 100c of the child that the father is about to return home and will arrive one hour later, for example.

On acquiring notification that the father is about to return home from the agent 100a of the father, the agent 100b of the mother has an indication showing that the father is about to return home and will arrive at the house one hour later displayed on a device in the home, such as a television set, to inform the mother who is at home. The mother is capable of viewing the information acquired by the agent 100b of the mother and taking an action, such as preparing dinner in keeping with the father's arrival time.

Also, on acquiring notification that the father is about to return home from the agent 100a of the father, the agent 100c of the child has an indication showing that the father is about to return home and will arrive at the house one hour later displayed on a mobile information terminal in the possession of the child to inform the child. On viewing such information, the child may decide to return home from his/her current location or may visit another place if the father is not due home for an hour.

If, as one example, if the child decides to visit another place due to the father not being due home for an hour, the mother who is at home may become worried if the child is late in coming home. In such case, it is possible for the mother to have the agent 100b of the mother make an inquiry about where the child is to the agent 100c of the child. If an inquiry about where the child is has been made from the agent 100b of the mother to the agent 100c of the child, the agent 100c of the child sends information on the present position out of the information on the current location and the like in reply to the agent 100b. Once the agent 100b of the mother has acquired information on the current location of the child from the agent 100c of the child, the agent 100b has the information on the current location of the child displayed on a device in the home, such as a television set, to inform the mother who is at home. By doing so, it is possible to inform the mother who is at home of where the child has gone.

### (4) Fourth Example Operation

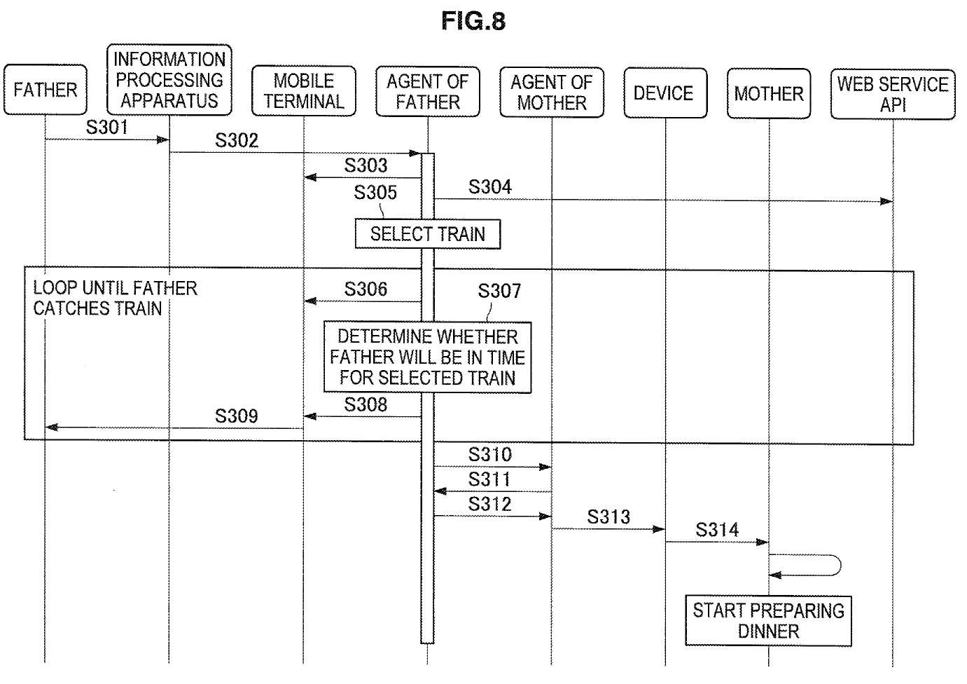

FIG. 8 is a diagram useful in explaining an example operation of an agent according to the present embodiment of the disclosure. FIG. 8 shows the operation of an agent when the father is about to return home in more detail. An example operation of an agent according to the present embodiment of the disclosure will now be described with reference to FIG. 8.

Once the father inputs an indication showing that he is about to return home into the information processing apparatus 10a (a personal computer) (step S301), notification that the father who is the user is about to return home is given from the information processing apparatus 10a to the agent 100a (step S302). The agent 100a has a mobile terminal 11a held by the father acquire the current location using GPS or the like (step S303), accesses the API of a web service that provides a train timetable to investigate a train timetable, and thereby acquires information on such train timetable (step S304). The agent 100a selects a suitable train for the father to catch from the location information acquired from the mobile terminal 11a and the information on the train timetable (step S305).

After this, the agent 100a regularly monitors the current location of the mobile terminal 11a (step S306). The agent 100a then determines whether the father will be in time for the train set in step S305 described above (step S307). If the father is moving slowly and the agent 100a determines that the father's current pace is not fast enough for the father to catch the train, the agent 100a notifies the mobile terminal 11a of such situation (step S308). By displaying on the screen, emitting a sound, and/or vibrating the case, the mobile terminal 11a that has received such notification urges the father to hurry up so as to not miss the train (step S309). By having the agent 100a urge the father to hurry up, it is possible to enable the father to catch the train set in step S305 described above.

While the father is returning home, the agent 100a of the father makes an inquiry to the agent 100b of the mother as to whether the mother is at home (step S310). On confirming from the constructed information that the mother is presently at home, the agent 100b of the mother sends a reply indicating that the mother is at home to the agent 100a of the father (step S311). In response, the agent 100a informs the agent 100b of the mother of the father's estimated time of arrival (ETA) at home (step S312). The information on the father's ETA can be calculated from the arrival time of the train, the time taken to return home from the station, and the like.

The agent 100b of the mother who has received information on the father's ETA from the agent 100a of the father gives notification of the father's ETA to the information processing apparatus 10b (for example, a television set) in the home (step S313). The information processing apparatus 10b that has received such notification displays information on the father's ETA on the screen, outputs sounds, or the like to inform the mother who is at home of the father's ETA (step S314). The mother can view the information on the father's ETA displayed on the information processing apparatus 10b in the home and can prepare dinner in keeping with the father's ETA.

In this way, an agent constructs information on a user by acquiring information about the user from various sources. The agent then replies to inquiries from the present user, other users, or other agents by using the constructed information as appropriate. When replying to an inquiry, the agent changes the disclosed content as appropriate in keeping with the relationship with the user who made the inquiry. By doing so, an agent according to the present embodiment is capable of preventing other users from excessively finding out information on the user that has been constructed.

### Example of User Interface

Next, the content of the user information constructed by an agent and a user interface for changing a setting of the range for disclosing information to the outside will be described by way of several examples.

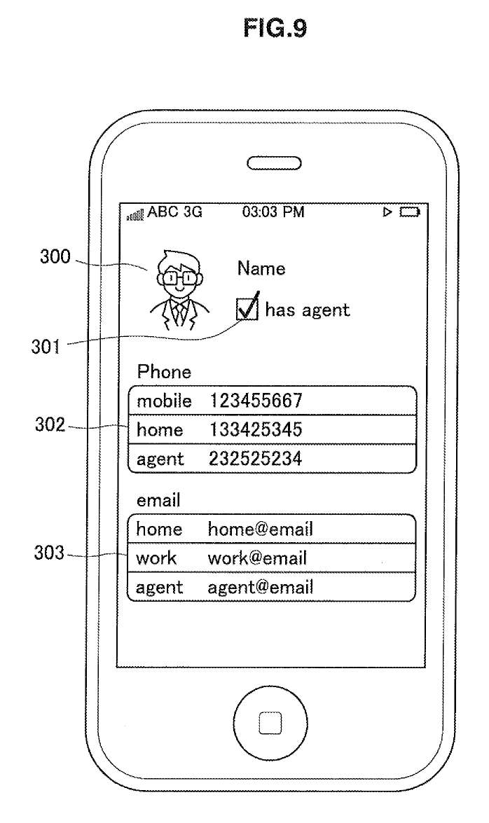

FIG. 9 is a diagram useful in explaining an example of a setting screen for personal information displayed on a mobile terminal such as a smartphone. In a setting screen 300 shown in FIG. 9, a check in a check box 301 indicates that the user has an agent and information on telephone numbers and e-mail addresses that are unique to such agent are indicated in a telephone number display region 302 and an e-mail display region 303.

As one example, when another user calls the telephone number of the agent shown in FIG. 9, the user's agent, not the user himself/herself, answers the call. Also, if the present user shown in FIG. 9 is incapable of taking a call when another user has called the user by telephone, the agent is capable of answering the call in place of the user.

As another example, if another user has transmitted an e-mail message to the e-mail address of the agent shown in FIG. 9, a reply is sent from the e-mail address of the agent of the user, not from the e-mail address of the user. Also, if the present user shown in FIG. 9 is not capable of promptly replying when another user has transmitted e-mail to the user, the agent is capable of sending an e-mail message in reply in place of the user.

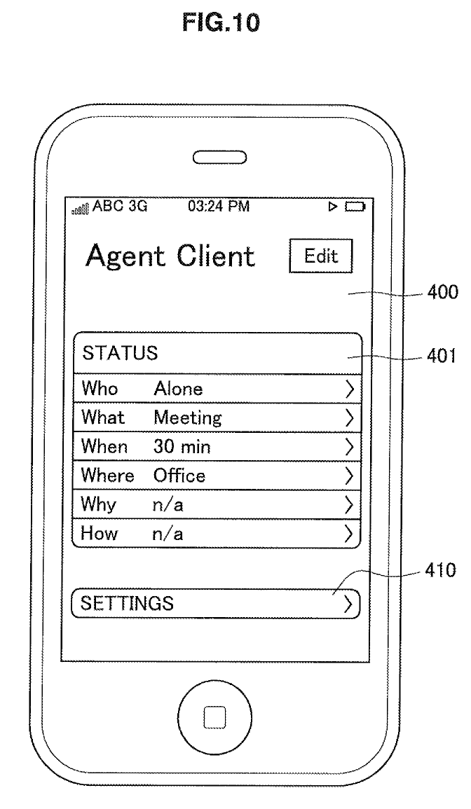

FIG. 10 is a diagram useful in explaining an example of a user interface for changing the content of the information on the user constructed by the agent. A setting screen 400 shown in FIG. 10 is used to directly change the content of the information on the user constructed according to 5W1H. By selecting one of “Who”, “What”, “When”, “Where, “Why”, and “How” displayed in a status display region 401 on the screen, the user is capable of editing the respective items. If the settings button 410 displayed in the setting screen 400 shown in FIG. 10 is selected, the display changes to a screen for making settings about disclosure of the information on the user constructed by the agent.

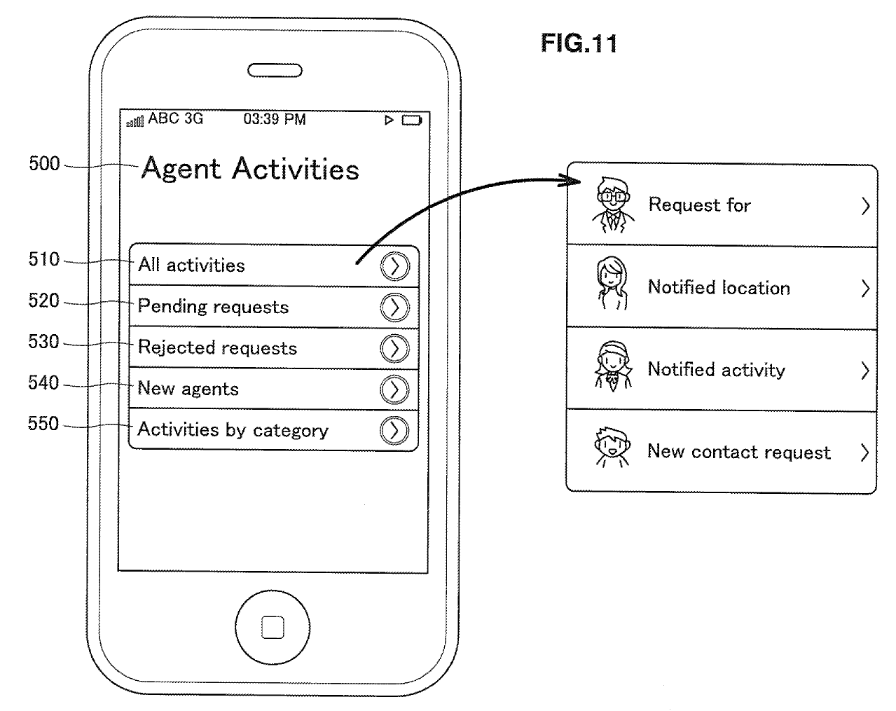

FIG. 11 is a diagram useful in explaining an example of a user interface for confirming the activities of an agent. Since as described earlier, the agent carries out varies processing in place of the user, it is preferable to enable the user to confirm what activities have been carried out by the agent. The user interface shown in FIG. 11 is an activity confirmation screen for browsing activities that have been carried out by the agent.

In the activity confirmation screen 500 shown in FIG. 11, a button 510 for confirming all of the activities carried out by the agent, a button 520 for confirming activities in a pending state in response to inquiries from other users or agents, a button 530 for confirming activities that were rejected in response to inquiries from other users or agents, a button 540 for confirming activities in response to requests from new agents, and a button 550 for confirming the activities carried out by the agent split into different categories are illustrated.

As one example, if the user selects the button 510 for confirming all of the activities carried out by the agent, the display changes from the activity confirmation screen 500 to a screen displaying the content of the activities of such agent. By looking at the activities carried out by the agent, the user becomes capable of changing the settings of the agent and/or directly contacting another user or agent that have been contacted by the agent.

### 2. Conclusion

According to the embodiment of the present embodiment described above, in place of a user, the agent of a user constructs personal information on the user from sources such as a web service on a network and information on an application being used by the user on a personal computer or the like. The agent of the present user then uses the constructed personal information to reply to another user or another agent who has made an inquiry to the present agent or to the agent of the present user.

When replying to an inquiry using the personal information of the user, the agent of the user changes the disclosed content of the constructed personal information in accordance with the relationship between the present user and another user or agent who has made such inquiry. By doing so, it is possible to prevent personal information on the user that has been gathered and constructed from being excessively disclosed to the outside.

The agent of a user is capable of carrying out communication, such as the exchanging of information, with another user or agent using information constructed for both users, external services, and the like. By automatically carrying out communication between agents, communication can be carried out smoothly between users even when a service for carrying out simultaneous communication between users (as examples, telephone or online chat) is not used.

It is also possible to produce a computer program for realizing the respective functions of an agent according to the present embodiment described above and install such program in a personal computer or the like. It is also possible to provide a computer-readable recording medium on which such a computer program is stored. As examples, such recording medium may be a magnetic disk, an optical disc, a magneto-optical disc, a flash memory, or the like. The computer program described above may also be distributed via a network, for example, without using a recording medium.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

an information gathering unit gathering information relating to a user;

an information constructing unit constructing, from the information gathered by the information gathering unit, personal information on the user based on information disclosed by the user; and

an information disclosure control unit dynamically changing a disclosed content of the personal information constructed by the information constructing unit, depending on another user.

(2) The information processing apparatus according to (1),

wherein the information constructing unit decides a relationship between the user and the other user from the information gathered by the information gathering unit, and the information disclosure control unit dynamically changes the disclosed content of the personal information constructed by the information constructing unit based on the relationship between the user and the other user decided by the information constructing unit.

(3) The information processing apparatus according to (1) or (2), further including:

an information disclosing unit disclosing the personal information whose disclosed content has been dynamically changed by the information disclosure control unit.

(4) The information processing apparatus according to (3),

wherein the information disclosing unit discloses the personal information whose disclosed content has been dynamically changed, in response to an inquiry from the other user.

(5) The information processing apparatus according to any one of (1) to (4), further including:

an inquiry notifying unit providing notification that there has been an inquiry from the other user.

(6) The information processing apparatus according to any one of (1) to (5), further including:

an inquiry replying unit replying to an inquiry from the other user in place of the user.

(7) The information processing apparatus according to (6),

wherein the inquiry replying unit replies, in place of the user, to another apparatus that has made an inquiry in place of the other user.

(8) The information processing apparatus according to (6),

wherein in response to an inquiry about a present state from the other user, the inquiry replying unit replies, in place of the user, by acquiring a present state of the user from the information constructing unit in place of the user.

(9) The information processing apparatus according to any one of (1) to (8), further including:

an information changing unit changing the personal information constructed by the information constructing unit.

(10) The information processing apparatus according to (9),

wherein the information changing unit changes the personal information constructed by the information constructing unit using information obtained by voice recognition.

(11) The information processing apparatus according to any one of (1) to (10),

wherein the information gathering unit gathers information relating to the user from another service on a network.

(12) The information processing apparatus according to any one of (1) to (11),

wherein the information gathering unit gathers information obtained by voice recognition as the information relating to the user.

(13) The information processing apparatus according to any one of (1) to (12),

wherein the information constructing unit constructs the personal information by managing, in a unit of a predetermined attribute the information gathered by the information gathering unit.

(14) The information processing apparatus according to any one of (1) to (13), further including:

an inquiry unit making an inquiry for personal information of another user gathered by another apparatus.

(15) An information processing method including:

gathering information relating to a user;

constructing, from the information gather in the step of gathering information, personal information on the user based on information disclosed by the user; and

dynamically changing a disclosed content of the personal information constructed in the step of constructing personal information, depending on another user.

(16) A computer program for causing a computer to execute:

gathering information relating to a user;

constructing, from the information gathered in the step of gathering information, personal information on the user based on information disclosed by the user; and

dynamically changing a disclosed content of the personal information constructed in the step of constructing personal information, depending on another user.

The present disclosure contains subject matter related to that disclosed in Japanese Priority Patent Application JP 2012-087218 filed in the Japan Patent Office on Apr. 6, 2012, the entire content of which is hereby incorporated by reference.

What is claimed is:

1. An information processing apparatus comprising:
an information gathering unit gathering information relating to a user;
an information constructing unit constructing, from the information gathered by the information gathering unit, personal information on the user based on information disclosed by the user; and
an information disclosure control unit dynamically changing a disclosed content of the personal information constructed by the information constructing unit, depending on another user.

2. The information processing apparatus according to claim 1,
wherein the information constructing unit decides a relationship between the user and the other user from the information gathered by the information gathering unit, and the information disclosure control unit dynamically changes the disclosed content of the personal information constructed by the information constructing unit based on the relationship between the user and the other user decided by the information constructing unit.

3. The information processing apparatus according to claim 1, further comprising:
an information disclosing unit disclosing the personal information whose disclosed content has been dynamically changed by the information disclosure control unit.

4. The information processing apparatus according to claim 3,
wherein the information disclosing unit discloses the personal information whose disclosed content has been dynamically changed, in response to an inquiry from the other user.

5. The information processing apparatus according to claim 1, further comprising:
an inquiry notifying unit providing notification that there has been an inquiry from the other user.

6. The information processing apparatus according to claim 1, further comprising:
an inquiry replying unit replying to an inquiry from the other user in place of the user.

7. The information processing apparatus according to claim 6,
wherein the inquiry replying unit replies, in place of the user, to another apparatus that has made an inquiry in place of the other user.

8. The information processing apparatus according to claim 6,
wherein in response to an inquiry about a present state from the other user, the inquiry replying unit replies, in place of the user, by acquiring a present state of the user from the information constructing unit in place of the user.

9. The information processing apparatus according to claim 1, further comprising:
an information changing unit changing the personal information constructed by the information constructing unit.

10. The information processing apparatus according to claim 9,
wherein the information changing unit changes the personal information constructed by the information constructing unit using information obtained by voice recognition.

11. The information processing apparatus according to claim 1,
wherein the information gathering unit gathers information relating to the user from another service on a network.

12. The information processing apparatus according to claim 1,
wherein the information gathering unit gathers information obtained by voice recognition as the information relating to the user.

13. The information processing apparatus according to claim 1,
wherein the information constructing unit constructs the personal information by managing, in a unit of a predetermined attribute the information gathered by the information gathering unit.

14. The information processing apparatus according to claim 1, further comprising:
an inquiry unit making an inquiry for personal information of another user gathered by another apparatus.

15. An information processing method comprising:
gathering information relating to a user;
constructing, from the information gather in the step of gathering information, personal information on the user based on information disclosed by the user; and
dynamically changing a disclosed content of the personal information constructed in the step of constructing personal information, depending on another user.

16. A computer program for causing a computer to execute:
gathering information relating to a user;
constructing, from the information gathered in the step of gathering information, personal information on the user based on information disclosed by the user; and
dynamically changing a disclosed content of the personal information constructed in the step of constructing personal information, depending on another user.
